(19) United States
(12) Patent Application Publication
(10) Pub. No.: US 2009/0199019 A1
(43) Pub. Date: Aug. 6, 2009

(54) APPARATUS, METHOD AND COMPUTER PROGRAM PRODUCT FOR REDUCING POWER CONSUMPTION BASED ON RELATIVE IMPORTANCE

(75) Inventors: Mika Tapani Hongisto, Oulu (FI); Kari Juhani Kolehmainen, Oulu (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/023,357

(22) Filed: Jan. 31, 2008

(51) Int. Cl. G06F 1/00

(52) U.S. Cl. 713/300

(57) ABSTRACT

An apparatus, method and computer program product are provided for reducing power consumption of an electronic device by taking into consideration not only the load history of each run-time entity operating on the electronic device, but also the importance of those run-time entities. In particular, a run-time entity's utilization of the hardware resources of an electronic device may be controlled in association with the importance level assigned to that run-time entity. Run-time entities having a lower importance level may be allocated less than the maximum operating power of the processor necessary to implement the run-time entity at the highest performance level.

### FIELD

Embodiments of the invention relate, generally, to power consumption and, in particular, to a technique for reducing power consumption that takes into consideration the relative importance of applications operating on an electronic device.

### BACKGROUND

As electronic devices (e.g., cellular telephones, personal digital assistants (PDAs), laptops, pagers, etc.) become smaller and smaller, minimizing power consumption of these devices becomes more and more important. Minimizing power consumption and, therefore, reducing the energy consumed by an electronic device reduces the heat output by the device, extends the lifetime of the device's battery, and enables smaller and less expensive devices to be made.

The energy consumption of an electronic device correlates linearly to the clock speed of the device's processor (e.g., central processing unit (CPU)) and quarterly to the voltage of the processor. (See Choi, K., Dantu, K., Cheng, W-C. & Pedram, M., Frame-Based Dynamic Voltage and Frequency Scaling for a MPEG Decoder, IEEE 2002). In particular, energy consumption (E) can be defined as follows:

$$E = {\int }_{0}^{t} ( {C}_{switched} {V}^{2} {f}_{clk} + VI ) d t \qquad ( 1 )$$

wherein t refers to time, C refers to the switched capacitance of the transistors of the processor, V refers to the voltage of the processor, f refers to the clock speed of the processor, and I refers to the current of the processor.

In order to reduce energy consumption, conventional power management techniques may shut power domains on and off according to need. (See L. Benini, A. Bogliolo, & G. De Micheli, A survey of design techniques for system-level dynamic power Management, IEEE Transactions on Very Large Scale Integration (VLSI) systems, vol, 8(3), June 2000). Dynamic power management techniques complement conventional power management techniques by providing performance scaling technologies. (See A. Sinha, & A. Chandrakasan, Dynamic voltage scheduling using adaptive filtering of workload traces, Proc. 14th International Conference on VLSI Design (VLSID '01), Bangalore, India, Jan. 3-7, 2001, pp. 221-226; and K. Flautner, & T. Mudge, Vertigo: automatic performance-setting for Linux, Proc. 5th Symposium on Operating Systems Design and Implementation (OSDI'02), Boston, Mass., Dec. 9-11, 2002).

Currently, several industry standard performance scaling approaches exist with the purpose of reducing the energy consumption of electronic devices. Examples of these approaches include Dynamic Voltage and Frequency Scaling (DVFS) and Dynamic Power Switching (DPS). In order to provide energy consumption savings, these, and similar, approaches provide the possibility of running the processor in a lower performance mode by, for example, reducing the clock speed and/or the voltage of the processor. In particular, these, and similar, approaches focus on minimizing the idle time of the processor by scaling down the performance of the processor when the processor load is low (See D. Grundwald, P. Levis, & K. Farkas, Policies for dynamic clock scheduling, Proc. 4th Symposium on Operating Systems Design and Implementation (OSDI'00), San Diego, Calif., October 2000, pp. 73-86, hereinafter “Grunwald et al.”). The idea behind many current implementations of these technologies is to scale the performance of the processor with minimal effect on the throughput of the system.

There exist, however, several drawbacks to the current implementations. For example, many performance scaling algorithms designed for DVFS, DPS and other performance scaling technologies base their performance setting decision (i.e., at what performance level to set the processor) on load history of the system. In other words, if the load of a particular process/task/application or similar component or software entity (referred to hereinafter as a “run-time entity”) has historically been high, the performance prediction of that run-time entity is also high. This may result in the processor being set to the maximum performance level for these run-time entities (i.e., virtually no energy savings). However, not all run-time entities are of equal importance, and some may not even be visible to the user. As a result, according to existing performance scaling technologies, the processor may be running at a full performance level, despite the fact that good perceived performance may be possible even if the processor were run on a lower performance level.

In addition, many of the existing scaling technologies can react slowly or inefficiently to rapidly changing system load. In particular, when the average load of a system is low and external events (e.g., graphical user interface (GUI) activity, incoming data traffic, etc.) cause peaks in the system load, current implementations can be problematic. For example, if the device has been configured to be less aggressive from an energy efficiency perspective, then the device can react quickly. Maximum performance may be quickly set and poor energy consumption savings may be realized, despite the fact that in some cases, the user may not see any difference whether the performance setting were high or low. Alternatively, if the devices have been configured to be more aggressive from an energy efficiency perspective, then the device may react slowly and the user's experience may be frustrating, since the necessary performance is not provided quickly enough. In addition, the performance may be provided after an interactive period when it is not needed anymore, thus increasing idle time.

A need, therefore, exists for an improved technique for reducing power consumption of an electronic device.

### BRIEF SUMMARY

In general, embodiments of the present invention provide an improvement by, among other things, providing a technique for controlling the utilization of the hardware resources of an electronic device (e.g., cellular telephone, personal digital assistant (PDA), laptop, pager, etc.) by various run-time entities (e.g., processes, applications, tasks, software components, etc.) executed on the device based on the relative importance of those run-time entities. Embodiments of the present invention provide a method, apparatus and computer program product for reducing power consumption by taking into consideration not only the load history of each run-time entity, but also how important the load is, how quickly it needs to be processed, and whether it needs to be processed at all.

In accordance with one aspect, an apparatus is provided for reducing power consumption of the apparatus based at least in part on the relative importance of applications executed on the apparatus. In one embodiment, the apparatus may include a processor configured to: (1) receive a definition of an importance level associated with an application; and (2) determine a performance level at which the processor should operate when processing the application based at least in part on the importance level associated with the application.

In accordance with another aspect, a method is provided for reducing power consumption of an apparatus based at least in part on the relative importance of applications executed on the apparatus. In one embodiment, the method may include: (1) receiving a definition of an importance level associated with an application; and (2) determining a performance level at which a processor should operate when processing the application based at least in part on the importance level associated with the application.

According to yet another aspect, a computer program product is provided for reducing power consumption of an apparatus based at least in part on the relative importance of applications executed on the apparatus. The computer program product contains at least one computer-readable storage medium having computer-readable program code portions stored therein. The computer-readable program code portions of one embodiment may include: (1) a first executable portion for receiving a definition of an importance level associated with an application; and (2) a second executable portion for determining a performance level at which a processor should operate when processing the application based at least in part on the importance level associated with the application.

In accordance with one aspect, an apparatus is provided for reducing power consumption of the apparatus based at least in part on the relative importance of applications executed on the apparatus. In one embodiment, the apparatus may include: (1) means for receiving a definition of an importance level associated with an application; and (2) means for determining a performance level at which a processor should operate when processing the application based at least in part on the importance level associated with the application.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of an entity capable of operating as an electronic device in accordance with embodiments of the present invention;

FIG. 2 is a schematic block diagram of a mobile station capable of operating in accordance with an embodiment of the present invention;

FIG. 3 is a flow chart illustrating the process of reducing power consumption in accordance with embodiments of the present invention; and

FIG. 4 is a schematic block diagram of the software architecture of one embodiment of the present invention.

### DETAILED DESCRIPTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overview:

In general, embodiments of the present invention provide an apparatus, method and computer program product for reducing the power consumption of an electronic device (e.g., cellular telephone, personal digital assistant (PDA), laptop, pager, etc.) by taking into consideration the relative importance of the run-time entities (e.g., processes, applications, tasks, software components, etc.) being executed on the device. In particular, according to one embodiment, each of the run-time entities being executed on an electronic device may be assigned an importance level. Using the importance levels assigned to various run-time entities, the device may scale the performance level of a processor operating on the device when executing run-time entities of less importance. By doing so, embodiments of the present invention may reduce the overall energy consumption of the device in a way that will likely go unnoticed by a user.

For example, if it is determined that a run-time entity is of little or no importance to the user (e.g., it is a background advertisement running on a webpage), the device of one embodiment may reduce the processing power used to execute this run-time entity by a certain percentage (e.g., 75%). This may be done, for example, by reducing the clock speed of the processor when executing the run-time entity. In contrast, if the importance level associated with a run-time entity is high, the processor may be operated at the maximum performance level (e.g., using maximum operating power and clock speed given the load) when executing that run-time entity.

Embodiments of the present invention provide an improvement over existing scaling technologies, which, as discussed above, may base their entire performance setting decision on the load history of the system, without regard to whether a user would actually see the effect of reducing the performance level of the processor in association with a particular run-time entity. As a result, embodiments of the present invention improve the energy efficiency of most current performance scaling algorithms and, therefore, further decrease the energy consumption of the devices on which they are supported. In addition, because embodiments of the present invention are preserving processing capacity for run-time entities that are of the most importance to the user, embodiments of the present invention may further improve a user's perceived performance and responsiveness of the run-time entities.

### Electronic Device & Exemplary Mobile Station:

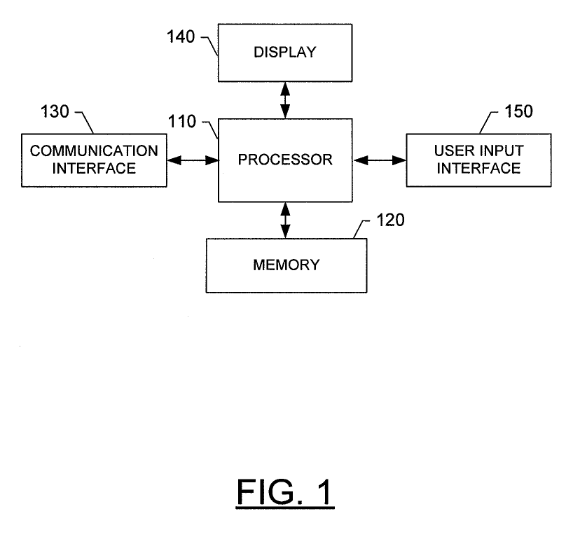

Referring now to FIG. 1, a block diagram of an entity capable of operating as an electronic device implementing the power-saving technique of embodiments of the present invention is shown. The entity may include various means for performing one or more functions in accordance with embodiments of the present invention, including those more particularly shown and described herein. It should be understood, however, that one or more of the entities may include alternative means for performing one or more like functions, without departing from the spirit and scope of the present invention. As shown, the entity capable of operating as the electronic device can generally include means, such as a processor 110 for performing or controlling the various functions of the entity.

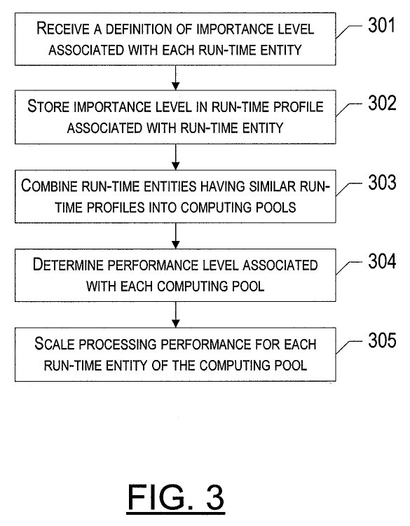

In particular, the processor 110, or similar means, may be configured to perform the processes discussed in more detail below with regard to FIG. 3. For example, the processor 110 may be configured to receive a definition of an importance level associated with a plurality of run-time entities (or applications) and to determine a performance level at which the processor 110 should operate when processing each of the run-time entities based at least in part on the importance level associated with each run-time entity. In one embodiment, in order to do so, the processor 110 may further be configured to define two or more groups of applications (referred to hereinafter as “computing pools”), wherein each computing pool has a range of importance levels associated with it (i.e., each of the applications within the computing pool fall within the range of importance levels associated with the computing pool). The processor 110 may thereafter be configured to define a performance level of the processor associated with each of the computing pools, rather than for each individual run-time entity. In other words, the processor 110 may be configured to define the performance level at which the processor 110 should operate when executing each of the applications within a given computing pool.

In one embodiment, the processor is in communication with or includes memory 120, such as volatile and/or non-volatile memory that stores content, data or the like. For example, the memory 120 typically stores content transmitted from, and/or received by, the entity. Also for example, the memory 120 typically stores software applications, instructions or the like for the processor to perform steps associated with operation of the entity in accordance with embodiments of the present invention.

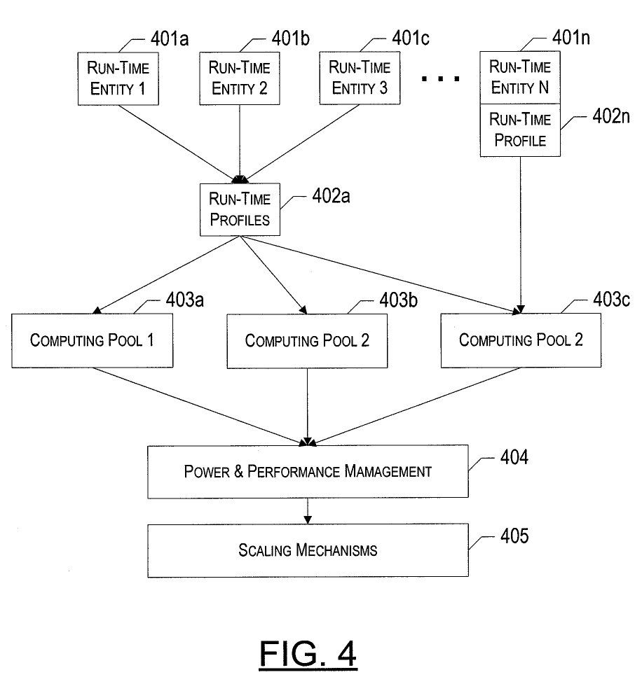

In particular, according to one embodiment, the memory may store computer program code or instructions for causing the processor to perform the operations discussed above and below with regard to FIG. 3. For example, the memory may store computer program code for reducing the power consumption of the electronic device by using the relative importance levels of run-time entities operating on the electronic device to determine the performance level at which the processor 110 should operate when executing each of the run-time entities. In particular, in one embodiment, the memory may store computer program code corresponding to the software architecture discussed below with regard to FIG. 4.

In addition to the memory 120, the processor 110 can also be connected to at least one interface or other means for displaying, transmitting and/or receiving data, content or the like. In this regard, the interface(s) can include at least one communication interface 130 or other means for transmitting and/or receiving data, content or the like, as well as at least one user interface that can include a display 140 and/or a user input interface 150. The user input interface, in turn, can comprise any of a number of devices allowing the entity to receive data from a user, such as a keypad, a touch-sensitive input device (e.g., touchscreen or touchpad), a joystick or other input device.

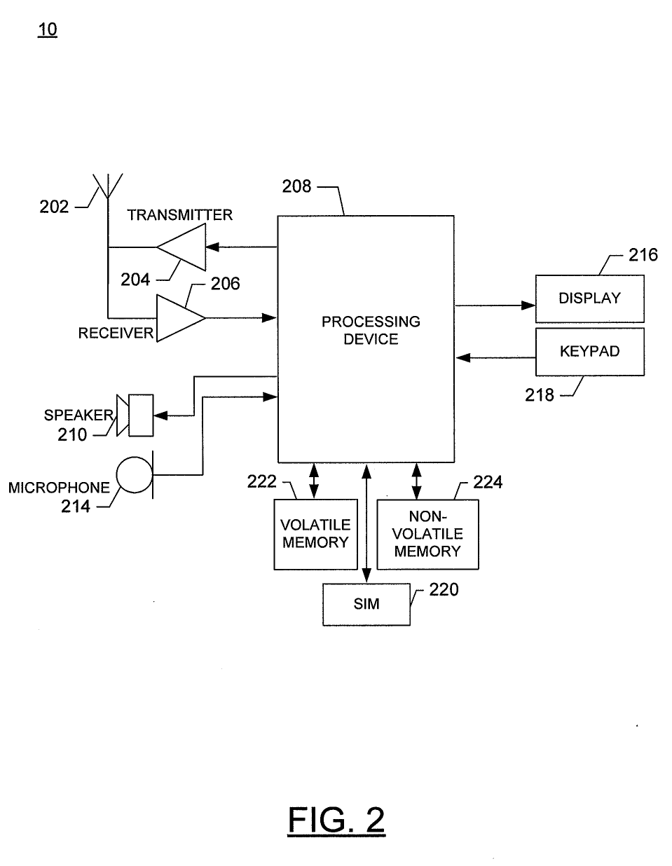

Reference is now made to FIG. 2, which illustrates one type of electronic device that would benefit from embodiments of the present invention. As shown, the electronic device may be a mobile station 10, and, in particular, a cellular telephone. It should be understood, however, that the mobile station illustrated and hereinafter described is merely illustrative of one type of electronic device that would benefit from embodiments of the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments of the present invention.

The mobile station includes various means for performing one or more functions in accordance with embodiments of the present invention, including those more particularly shown and described herein. It should be understood, however, that the mobile station may include alternative means for performing one or more like functions, without departing from the spirit and scope of the present invention. More particularly, for example, as shown in FIG. 2, in addition to an antenna 202, the mobile station 10 includes a transmitter 204, a receiver 206, and an apparatus that includes means, such as a processing device 208, e.g., a processor, controller or the like, that provides signals to and receives signals from the transmitter 204 and receiver 206, respectively, and that performs the various other functions described below including, for example, the functions relating to reducing the power consumption of the mobile station 10.

As discussed in more detail below with regard to FIG. 3, in one embodiment, the processor 208 may be configured to receive a definition of an importance level associated with a plurality of run-time entities (or applications) and to determine a performance level at which the processor 208 should operate when processing each of the run-time entities based at least in part on the importance level associated with each run-time entity. In one embodiment, in order to do so, the processor 208 may be further configured to determine the percentage of the processor's maximum operating power at which the processor 208 should operate when processing the run-time entity. For example, if the importance level associated with the run-time entity is less than the maximum importance level, the processor 208 may be configured to run at less than 100 percent of the processor's maximum operating power. In one embodiment, the processor 208 may be further configured to assign a clock speed at which the processor 208 should operate when executing the run-time entity, wherein the clock speed is based at least in part on the determined performance level and/or percentage of the maximum operating power associated with executing the run-time entity.

As one of ordinary skill in the art would recognize, the signals provided to and received from the transmitter 204 and receiver 206, respectively, may include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 208, such as a processor, controller or other computing device, may include the circuitry required for implementing the video, audio, and logic functions of the mobile station and may be capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 208 thus also includes the functionality to convolutionally encode and interleave message and data prior to modulation and transmission. The processing device can additionally include an internal voice coder (VC) 208A, and may include an internal data modem (DM) 208B. Further, the processing device 208 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 210, a ringer 212, a microphone 214 and a display 216, all of which are coupled to the controller 308. The user input interface, which allows the mobile device to receive data, can comprise any of a number of devices allowing the mobile device to receive data, such as a keypad 218, a touch-sensitive input device (not shown), a microphone 214, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 220, a removable user identity module (R-UIM) (not shown), or the like, which typically stores information elements related to a mobile subscriber. In addition to the SIM, the mobile device can include other memory. In this regard, the mobile station can include volatile memory 222, as well as other non-volatile memory 224, which can be embedded and/or may be removable. For example, the other non-volatile memory may be embedded or removable multimedia memory cards (MMCs), secure digital (SD) memory cards, Memory Sticks, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device.

The memory can also store content. The memory may, for example, store computer program code for an application and other computer programs. For example, in one embodiment of the present invention, the memory may store computer program code for receiving a definition of an importance level associated a plurality of run-time entities (or applications) and determining a performance level at which the processor 208 should operate when processing each of the run-time entities based at least in part on the importance level associated with each run-time entity. In one embodiment, the memory may store computer program code corresponding to the software architecture illustrated in FIG. 4, which is discussed in more detail below.

The apparatus, method and computer program product of embodiments of the present invention are primarily described in conjunction with mobile communications applications. It should be understood, however, that the apparatus, method and computer program product of embodiments of the present invention can be utilized in conjunction with a variety of other applications, both in the mobile communications industries and outside of the mobile communications industries. For example, the apparatus, method and computer program product of embodiments of the present invention can be utilized in conjunction with wireline and/or wireless network (e.g., Internet) applications.

### Method of Reducing Power Consumption Based on Relative Importance

Reference is now made to FIG. 3, which illustrates the operations that may be taken in order to reduce the power consumption of an electronic device based at least in part on the relative importance of various run-time entities (e.g., applications, processes, tasks, software components, etc.) being executed on the electronic device. Reference will also be made to FIG. 4, which provides a schematic block diagram of the software architecture that may be used to implement the process of FIG. 3.

As shown in FIG. 3, the process may begin at Block 301, when an electronic device and, in particular a processor or similar means operating on the electronic device, receives a definition of an importance level associated with each of a plurality of run-time entities 401a, 401b, 401c, 401n (as shown in FIG. 4). As noted above, a run-time entity refers to any application, process, task, or other software component being executed on the electronic device at any given time. In one embodiment, the importance level associated with a run-time entity may be defined by a user of the electronic device, which may include, for example, a software and/or hardware developer, an end user, or the like. In particular, a user may define the importance level associated with a specific run-time entity, or with a category of run-time entities. For example, a user may define the importance level of all browser flash plug-ins and/or screensavers as low or very low, while defining the importance level of other run-time entities (e.g., a 3G communication stack, video call decoding and/or other run-time entities having valid real-time requirements) as high or very high. Where, for example, an end user is defining the importance levels, the user may control the performance level of third-party applications, such as games, or the like. Otherwise, (e.g., where a software and/or hardware developer, or the like is primarily responsible for defining importance levels) the process described herein may be substantially transparent to the end user. In another embodiment, the run-time entities themselves may request a specific importance level using, for example, an application program interface (API).

Alternatively, according to yet another embodiment, priorities assigned by an operating system scheduler may be used to define the importance level associated with respective run-time entities. In particular, as one of ordinary skill in the art will recognize, the operating system of many electronic devices may employ a scheduler that prioritizes the run-time entities being executed on the electronic device in order to determine in what order those run-time entities should be executed. For example, Symbian OS (the open mobile operating system) provides priorities ranging from zero to 64 to each run-time entity executing on the electronic device. The Symbian OS operating system then executes each of the run-time entities in order based on their assigned priorities. One embodiment of the present invention may use these assigned priorities as an indication of the importance level associated with each run-time entity (e.g., high priority signifies high importance, etc.).

As one of ordinary skill in the art will recognize, the foregoing techniques for defining the importance level associated with respective run-time entities are provided for exemplary purposes only and should not be taken in any way as limiting the scope of embodiments of the present invention, as other similar techniques may likewise be used without departing from the spirit and scope of embodiments of the present invention.

Once the electronic device (e.g., processor or similar means operating on the electronic device) has received the definition of the importance level associated with a run-time entity, the device (e.g., processor or similar means) may save the importance level, at Block 302, as a run-time profile 402a, 402n associated with the run-time entity. As shown in FIG. 4, an individual run-time profile 402n may be saved as metadata associated with the corresponding run-time entity 401n itself. In this embodiment, the run-time profile 402n may be hard-coded into the run-time entity (or into any other data structure in memory) or modified dynamically via a kernel extension. Alternatively, or in addition, the run-time profiles associated with several run-time entities 401a, 401b, 401c may be saved together 402a in the form of a listing of run-time entities and their corresponding run-time profiles.

The electronic device (e.g., processor or similar means operating on the electronic device) may then, at Block 303, combine the run-time entities 401a, 401b, 401c, 401n into two or more computing pools 403a, 403b, 403c wherein each computing pool is associated with a particular range of importance levels. For example, assuming that the importance levels assigned to each of the run-time entities correspond to the Symbian OS priorities discussed above, a first computing pool 403a may correspond to all run-time entities having a priority (and, therefore, in this embodiment, an importance level) of 15 to 64, a second computing pool 403b to all run-time entities having a priority/importance level of 10 to 14, and a third computing pool 403c for all run-time entities having a priority/importance level of 0 to 9. As noted above, use of the Symbian OS, and similar, priority levels is just one example of how the importance levels may be defined, and use of these priority levels in the description should not be taken in any way as limiting embodiments of the present invention to such use.

Once the computing pools have been defined, the electronic device (e.g., processor or similar means operating on the electronic device to execute the Power and Performance Management software component 404, shown in FIG. 4) may, at Block 304, determine the performance scaling associated with each computing pool. In other words, for each computing pool, the electronic device (e.g., processor or similar means) may determine the performance level at which the processor should operate when executing the run-time entities of that computing pool. For example, the electronic device (e.g., processor or similar means) may determine the percentage of the maximum operating power associated with the processor at which the processor should operate when executing the run-time entity.

As with current performance scaling technologies, discussed above, embodiments of the present invention may use the historical load associated with a run-time entity to predict the future load and, therefore, to assign hardware resources. However, embodiments of the present invention may further take into consideration how important the run-time entity is to the user, if at all. For example, while run-time entities considered to be of high importance may be allocated 100% of the hardware resources required to implement the run-time entity at the highest performance level (given the historical load of the run-time entity), run-time entities considered to be of medium or low importance may be allocated a lesser percentage (e.g., 50% or 25%) of the hardware resources available.

In one embodiment, the foregoing determination may be made by using importance as an additional parameter in a scaling algorithm. For example, as one of ordinary skill in the art will recognize, many performance scaling technologies use weight values to extend performance scaling algorithms. For example, according to the Exponential Moving Average algorithm (AVG_{N}), a prediction algorithm originally proposed in M. Weiser, B. Welch, A. Demers, and S. Shenker, Scheduling for Reduced CPU Energy, in First Symposium on Operating Systems Design and Implementation, pages 13-23, November 1994 (hereinafter “Weiser et al.”), an exponential moving average with decay N of the previous time intervals is used to predict the processor utilization for the current time interval. Under AVG_{N}, a weighted utilization, or Wₜ is computed at each interval (at time t) as a function of the utilization of the previous interval Uₜ₋₁ and the previous weighted utilization Wₜ₋₁. (See Grunwald et al.). In particular,

$$W [ t ] = \frac{N * W [ t - 1 ] + U [ t - 1 ]}{N + 1} \qquad ( 2 )$$

According to one embodiment of the present invention, a weighted utilization may be computed for each computing pool that is based not only on the exponential moving average decay of the previous time intervals, but also on the importance assigned to the run-time entities of that computing pool. For example, the weighted utilizations for each computing pool may be calculated as follows:

Wp1=W(t), priority≧15 (3)

Wp2=W(t), 10≦priority≦14 (4)

Wp3=W(t), priority≦9 (5)

W[t]=min(W[t1],100%)+min(W[t2], x %)+min(W[t3], y %) (6)

Where,

if(Wp1+Wp2+Wp3=Current_Perf), then (7)

{if(Wp3>0), then W[t3]=Wp3+γ; W[t2]=Wp2; and W[t1]=Wp1 (8)

else if(Wp2>0), then W[t2]=Wp2+β; W[t3]=Wp3; and W[t1]=Wp1 (9)

else W[t1]=Wp1+α; W[t2]=Wp2; and W[t3]=Wp3} (10)

else W[t3]=Wp3; W[t2]=Wp2; and W[t1]=Wp1 (11)

where Wp1, Wp2, and Wp3 represent the predicted utilization (not taking into consideration importance) associated with the first computing pool 403a (including run-entities having the highest importance, or priorities from 15 to 64), the second computing pool 403b (including run-entities having medium importance, or priorities from 10 to 14) and the third computing pool 403c (including run-entities having the lowest importance, or priorities from 0 to 9), respectively; W[t1], W[t2] and W[t3] represent the weighted resource utilization associated with respective pools (taking into consideration importance); Current_Perf refers to the current performance level of the operating system; coefficients α, β, γ are assigned in order to scale the weighted utilization associated with each computing pool based on the importance associated with the run-time entities included in the respective computing pools; and 100, x and y represent the percentage of available processing power allocated to the run-time entities of the corresponding computing pool; x is an integer value less than 100; and y is an integer value less than x.

To illustrate, consider the following examples. Assume for example that the predicted utilizations calculated, for example using the AGV_{N} algorithm, for each of the computing pools is 20%, 20% and 40%, respectively (i.e., Wp1=20%, Wp2=20%, and Wp3=40%), and further that the current performance level of the system is 85% (i.e., Current_Perf=85%). Because 20%+20%+40%, or 80%, is not equal to the current performance of the operating system, or 85%, equation (11) above applies. In other words, W[t1] is equal to Wp1, W[t2] is equal to Wp2, and W[t3] is equal to Wp3 (i.e., no weighting is applied). Assuming further that x is equal to 70% and y is equal to 30%, equation (6) becomes

W[t]=min(20%, 100%)+min(20%, 70%)+min(40%, 30%)=20%+20%+30%=70% (6a)

Because the overall system utilization (or W[t]) is 70%, the system's performance level may be reduced from 85% to 70%. This new system performance level may be used for the next time window (e.g., 50 ms).

Now assume that the current system performance level is 80%, which is now equal to the sum of the predicted utilizations (i.e., (Wp1+Wp2+Wp3)=Current_Perf). In this example, equations (8), (9) and (10), and not equation (11), apply. Looking to equation (8), because Wp3 (which is equal to 40%), is greater than zero, W[t3] is equal to Wp3 plus the coefficient γ. Assuming, for example, that γ is equal to 5%, W[t3] is equal to 45% (i.e., 40%+5%). In addition, W[t1] and W[t2] are equal to Wp1 and Wp2, respectively. Equation (6), therefore, becomes

W[t]=min(20%, 100%)+min(20%, 70%)+min(45%, 30%)=20%+20%+30%=70% (6b)

As in the previous example, the measured resource utilization of 70% is less than the system performance of 80%, resulting in a decrease in the performance level for the next time window.

In yet another example, assume that Wp1 is equal to 50%, Wp2=30% and Wp3 is equal to 0. Assume further that the system performance is 80%; x and y are again equal to 70% and 30%, respectively; and β is equal to 10%. Looking first to equation (7), the sum of the predicted utilization (Wp1+Wp2+Wp3), or 80%, is equal to the system performance. As a result, equations (8), (9) and (10) apply. Looking to equation (8), Wp3, which is equal to zero, is not greater than zero. As a result, we look to equation (9). Based on equation (9), because Wp2, which is equal to 30%, is greater than zero, W[t2] is equal to Wp2 plus β (i.e., 30%+10%) or 40%; W[t1] is equal to Wp1 and W[t3] is equal to Wp3. Based on the foregoing, equation (6) becomes

W[t]=min(50%, 100%)+min(40%, 70%)+min(0%, 30%)=50%+40%+0%=90% (6c)

Because the measured utilization, or 90%, is greater than the system performance of 80%, the performance level for the next time window may be increased.

As one of ordinary skill in the art will recognize, while the foregoing uses the AVG_{N} prediction algorithm, other prediction algorithms (e.g., Past (bounded-delay limited-past), also proposed in Weiser et al., etc.) may also be used without departing from the spirit and scope of embodiments of the present invention. Use of AVG_{N} is, therefore, for exemplary purposes only and should not be taken in any way as limiting the scope of embodiments of the invention.

According to embodiments of the present invention, the foregoing analysis could be triggered by a timer, scheduler context switches, interrupts, and/or other events that may be relevant from a performance and power management perspective.

Finally, at Block 305, the electronic device and, in particular, a processor or similar means operating on the electronic device and executing, for example, the Scaling Mechanism software component 405, shown in FIG. 4, may scale the processing performance for each run-time entity of a certain computing pool based on the performance level for that computing pool determined at Block 304. In particular, the electronic device (e.g., processor or similar means) may use existing hardware used to support performance scaling technologies, such as DVFS, DPS, and the like, to reduce the operating power of the processor in accordance with the weighted utilization calculated above, wherein the weighted utilizations of embodiments of the present invention take into consideration the importance level of the various run-time entities (and not just the load history). In one embodiment, in order to reduce the operating power of the processor, the clock speed at which the processor operates may be reduced.

As one of ordinary skill in the art will recognize, while the above assumes that the run-time entities are first divided into computing pools prior to determining the performance level to be associated with the computing pool and, by extension, the run-time entities of that computing pool, embodiments of the present invention may forego this step and, instead, determine the performance level associated with each run-time entity itself, based on the individual run-time entity's importance level. Use of computing pools, however, reduces implementation complexity and provides a less granular look at the system's operations.

Based on the foregoing, embodiments of the present invention control a run-time entity's utilization of existing hardware resources based, not only on the load history of that run-time entity, but also on the importance level associated with that run-time entity. Embodiments of the present invention, therefore, enable the electronic device to reduce power and energy consumption by reducing the performance level of applications about which the user may not care and/or in relation to which the user may not notice a decrease in the performance level. By reducing energy and power consumption, embodiments of the present invention reduce heat output of the electronic device, extend device battery life, and enable the manufacture of smaller and less expensive electronic devices.

### Conclusion:

As described above and as will be appreciated by one skilled in the art, embodiments of the present invention may be configured as an apparatus and method. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as processor 110 discussed above with reference to FIG. 1 and/or processor 208 discussed above with reference to FIG. 2, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus (e.g., processor 110 of FIG. 1 and/or processor 208 of FIG. 2) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus comprising:
a processor configured to:
receive a definition of an importance level associated with an application; and
determine a performance level at which the processor should operate when processing the application based at least in part on the importance level associated with the application.

2. The apparatus of claim 1, wherein the processor has a maximum operating power associated therewith, and wherein in order to determine a performance level at which the processor should operate, the processor is further configured to:
determine a percentage of the processor's maximum operating power at which the processor should operate when processing the application based at least in part on the importance level associated with the application.

3. The apparatus of claim 2, wherein the percentage is further based at least in part on a past load associated with the application.

4. The apparatus of claim 2, wherein if the importance level associated with the application is less than a maximum importance level, the processor is configured to operate at less than 100 percent of the processor's maximum operating power when processing the application.

5. The apparatus of claim 1, wherein the importance level associated with the application is based at least in part on an operating system priority assigned to the application.

6. The apparatus of claim 1, wherein in order to receive a definition of an importance level associated with an application, the processor is further configured to:
receive the importance level as an input from a user of the apparatus.

7. The apparatus of claim 1, wherein the processor is further configured to:
assign a clock speed at which the processor should operate when processing the application based at least in part on the determined performance level.

8. The apparatus of claim 1, wherein the processor is further configured to:
receive a definition of an importance level associated with respective applications of a plurality of applications; and
define two or more groups of applications, wherein respective groups have a range of importance levels associated therewith, and wherein in order to determine a performance level at which the processor should operate, the processor is further configured to determine, for respective groups of applications, a performance level at which the processor should operate when processing any application within the group.

9. A method comprising:
receiving a definition of an importance level associated with an application; and
determining a performance level at which a processor should operate when processing the application based at least in part on the importance level associated with the application.

10. The method of claim 9, wherein the processor has a maximum operating power associated therewith, and wherein determining a performance level at which the processor should operate further comprises:
determining a percentage of the processor's maximum operating power at which the processor should operate when processing the application based at least in part on the importance level associated with the application.

11. The method of claim 10, wherein the percentage is further based at least in part on a past load associated with the application.

12. The method of claim 10, wherein if the importance level associated with the application is less than a maximum importance level, the method further comprises:
operating the processor at less than 100 percent of the processor's maximum operating power when processing the application.

13. The method of claim 9, wherein the importance level associated with the application is based at least in part on an operating system priority assigned to the application.

14. The method of claim 9, wherein receiving a definition of an importance level associated with an application further comprises:
receiving the importance level as an input from a user.

15. The method of claim 9 further comprising:
assigning a clock speed at which the processor should operate when processing the application based at least in part on the determined performance level.

16. The method of claim 9 further comprising:
receiving a definition of an importance level associated with respective applications of a plurality of applications; and
defining two or more groups of applications, wherein respective groups have a range of importance levels associated therewith, and wherein determining a performance level at which the processor should operate further comprises determining, for respective groups of applications, a performance level at which the processor should operate when processing any application within the group.

17. A computer program product comprising at least one computer-readable medium having computer-readable program code portions stored therein, said computer-readable program code portions comprising:
a first executable portion for receiving a definition of an importance level associated with an application; and
a second executable portion for determining a performance level at which a processor should operate when processing the application based at least in part on the importance level associated with the application.

18. The computer program product of claim 17, wherein the processor has a maximum operating power associated therewith, and wherein the second executable portion is configured to determine a percentage of the processor's maximum operating power at which the processor should operate when processing the application based at least in part on the importance level associated with the application.

19. The computer program product of claim 18, wherein the percentage is further based at least in part on a past load associated with the application.

20. The computer program product of claim 18, wherein if the importance level associated with the application is less than a maximum importance level, the computer-readable program code portions further comprise:
a third executable portion for operating the processor at less than 100 percent of the processor's maximum operating power when processing the application.

21. The computer program product of claim 17, wherein the importance level associated with the application is based at least in part on an operating system priority assigned to the application.

22. The computer program product of claim 17, wherein the first executable portion is configured to receive the importance level as an input from a user.

23. The computer program product of claim 17, wherein the computer-readable program code portions further comprise:
a third executable portion for assigning a clock speed at which the processor should operate when processing the application based at least in part on the determined performance level.

24. The computer program product of claim 17, wherein the computer-readable program code portions further comprise:
a third executable portion for receiving a definition of an importance level associated with respective applications of a plurality of applications; and
a fourth executable portion for defining two or more groups of applications, wherein respective groups have a range of importance levels associated therewith, and wherein the second executable portion is further configured to determine, for respective groups of applications, a performance level at which the processor should operate when processing any application within the group.

25. An apparatus comprising:
means for receiving a definition of an importance level associated with an application; and
means for determining a performance level at which a processor should operate when processing the application based at least in part on the importance level associated with the application.
